(19) United States
(12) Patent Application Publication
(10) Pub. No.: US 2026/0181623 A1
(43) Pub. Date: Jun. 25, 2026

(54) GROUP-BASED RADIO RESOURCE ALLOCATION BETWEEN A TN AND AN NTN NETWORKS

(71) Applicants: MEDIATEK INC., Hsinchu City (TW); NATIONAL TAIWAN UNIVERSITY, Taipei (TW)

(72) Inventors: Hao-Wei LEE, Hsinchu City (TW); I-Kang FU, Hsinchu City (TW); Chun-Chia CHEN, Hsinchu City (TW); Chen-I LIAO, Hsinchu City (TW); Hung-Yu WEI, Taipei City (TW)

(21) Appl. No.: 19/539,470

(22) Filed: Feb. 13, 2026

Related U.S. Application Data
(63) Continuation of application No. 18/356,106, filed on Jul. 20, 2023, now Pat. No. 12,581,478.
(60) Provisional application No. 63/370,132, filed on Aug. 2, 2022.

(51) Int. Cl. H04W 72/121; H04B 7/185

(52) U.S. Cl. CPC H04W 72/121; H04B 7/18513

(57) ABSTRACT

A method for performing in-band spectrum sharing in a mixed TN-NTN system is provided. The method is performed by a user equipment (UE). The UE receives reference signal (RS) configuration information from a satellite or TN base station and obtains measurement results indicative of coupling loss or interference based on the RS configuration. The UE transmits a measurement report to the satellite or an uplink RS to the TN base station for resource allocation decisions. The UE operates according to resource allocation results indicating a partition of shared radio resources across frequency, time, or polarization domains to mitigate interference. Finally, the UE communicates using the allocated resource portion of the shared radio resources.

### CROSS REFERENCE TO RELATED APPLICATIONS

This application is a continuation of pending U.S. patent application Ser. No. 18/356,106, filed Jul. 20, 2023, the entirety of which is incorporated by reference herein.

### TECHNICAL FIELD

The present disclosure relates generally to mobile communication networks. In particular, the disclosure relates to coordinated allocation of radio resources between terrestrial and non-terrestrial networks (TN; NTN).

### BACKGROUND

Coverage extension and capacity enhancement are two primary challenges in the field of mobile networks. It has been observed that there exists a complementary demand for both terrestrial network (TN) spectrum and non-terrestrial network (NTN) spectrum across different geographic locations. On one hand, in densely populated areas, there is a significant need for TN spectrum, while NTN spectrum remains underutilized. On the other hand, in remote areas, there is no TN coverage, resulting in unused TN spectrum, and a severe shortage of NTN spectrum.

In order to address this complementary demand, it is desirable to leverage the currently unused spectrum to augment system capacity and spectral efficiency, so as to provide global service for multimode devices through coordination between TN and NTN.

### SUMMARY

Aspects of the disclosure provide a user equipment (UE) for performing in-band spectrum sharing in a mixed system comprising a terrestrial network (TN) and a non-terrestrial network (NTN). The UE comprises one or more processors and a transceiver. The UE receives, from at least one of a satellite or a TN base station, reference signal (RS) configuration information including one or more RS configuration parameters, the RS configuration information being used for acquiring information used for deciding radio resource allocation for the in-band spectrum sharing between the TN and the NTN is to be transmitted. Based on the RS configuration information, the UE obtains measurement results indicative of coupling loss and/or interference between the TN and the NTN for the in-band spectrum sharing, wherein the measurement results are obtained based on performing at least one of: (i) measure one or more reference signals in accordance with the RS configuration information, and/or (ii) measuring interference on a time-frequency resource in accordance with the RS configuration information. The UE transmits, in accordance with the RS configuration information, at least one of: (i) a measurement report including the measurement results indicative of coupling loss and/or mutual interference between the TN and the NTN to the satellite, or (ii) an uplink reference signal to the TN base station for measurement by the TN base station, wherein the uplink reference signal is for acquiring information used for deciding the radio resource allocation results for the in-band spectrum sharing. The UE operates in accordance with resource allocation results implemented by at least one of the satellite or the TN base station, wherein the resource allocation results indicate a partition of shared radio resources to mitigate interference between the TN and the NTN for the in-band spectrum sharing across at least one of a frequency domain, a time domain, and/or a polarization direction. The UE communicates using at least one resource portion of the shared radio resources in accordance with the resource allocation results.

Aspects of the disclosure provide a method for performing in-band spectrum sharing in a mixed terrestrial network (TN) and non-terrestrial network (NTN) system. The method is performed by the UE. The method comprises receiving, from at least one of a satellite or a TN base station, reference signal (RS) configuration information, the RS configuration information including information regarding how a reference signal used for acquiring information used for deciding radio resource allocation between the TN and the NTN is to be transmitted. The method comprises obtaining, based on the RS configuration information, measurement results indicative of coupling loss and/or interference between the TN and the NTN for the in-band spectrum sharing, by performing at least one of: (i) measure one or more reference signals in accordance with the RS configuration information, and/or (ii) measuring interference on a shared time-frequency resource in accordance with the RS configuration information. The method comprises transmitting, in accordance with the RS configuration information, at least one of: (i) a measurement report including the measurement results indicative of coupling loss and/or mutual interference between the TN and the NTN to the satellite, or (ii) an uplink reference signal to the TN base station for measurement by the TN base station, wherein the uplink reference signal is for acquiring information used for deciding the radio resource allocation results for the in-band spectrum sharing. The method comprises operating in accordance with resource allocation results implemented by at least one of the satellite or the TN base station, wherein the resource allocation results indicate a partition of shared radio resources to mitigate interference between the TN and the NTN for the in-band spectrum sharing across at least one of a frequency domain, a time domain, and/or a polarization direction. The method comprises communicating using at least one resource portion of the shared radio resources in accordance with the resource allocation results.

Aspects of the disclosure also provide a non-transitory computer-readable medium storing instructions. The instructions, when executed by a processor, can cause the processor to perform the above method for performing in-band spectrum sharing in a mixed TN-NTN system.

Note that this summary section does not specify every embodiment and/or incrementally novel aspect of the present disclosure or claimed invention. Instead, the summary only provides a preliminary discussion of different embodiments and corresponding points of novelty. For additional details and/or possible perspectives of the invention and embodiments, the reader is directed to the Detailed Description section and corresponding figures of the present disclosure as further discussed below.

### BRIEF DESCRIPTION OF THE DRAWINGS

Various embodiments of this disclosure that are proposed as examples will be described in detail with reference to the following figures, wherein like numerals reference like elements, and wherein:

FIG. 1 illustrates a common scenario where there are varying usage rates of the non-terrestrial network (NTN) spectrum and the terrestrial network (TN) spectrum in different geographic locations;

FIGS. 2A-2D show typical observations regarding the uplink and downlink performance of the NTN when there is interference from TN base stations (TN BSs) and TN user equipments (TN UEs);

FIG. 3 shows a non-limiting example of the infrastructure of a coordinated TN-NTN framework, in accordance with embodiments of the disclosure;

FIG. 4 shows a non-limiting example of a scheme for allocating radio resources between NTN UEs and TN BSs, in accordance with embodiments of the disclosure;

FIG. 5 shows a block diagram of an apparatus for performing the coordinated allocation of radio resources between NTN UEs and TN BSs, in accordance with embodiments of the disclosure;

FIG. 6 shows a flow chart of a process for performing the coordinated allocation of radio resources between NTN UEs and TN BSs, in accordance with embodiments of the disclosure;

FIG. 7 shows a signal flow chart depicting the interaction between the resource allocation apparatus (represented as a separated server and a controller), the satellite, and the TN BS, in accordance with embodiments of the disclosure;

FIG. 8 shows a signal flow chart depicting the interaction between the resource allocation apparatus (represented as a separated server and a controller), the satellite, the TN BS, and the NTN UE, in accordance with embodiments of the disclosure; and

FIG. 9 shows a signal flow chart depicting the interaction between the resource allocation apparatus (represented as a separated server and a controller), the satellite, the TN BS, and the NTN UE, in accordance with embodiments of the disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting.

For example, the order of discussion of the different steps as described herein has been presented for the sake of clarity. In general, these steps can be performed in any suitable order. Additionally, although each of the different features, techniques, and configurations, etc., herein may be discussed in different places of this disclosure, it is intended that each of the concepts can be executed independently of each other or in combination with each other. Accordingly, the present disclosure can be embodied and viewed in many different ways.

Furthermore, as used herein, the words “a,” “an,” and the like generally carry a meaning of “one or more,” unless stated otherwise.

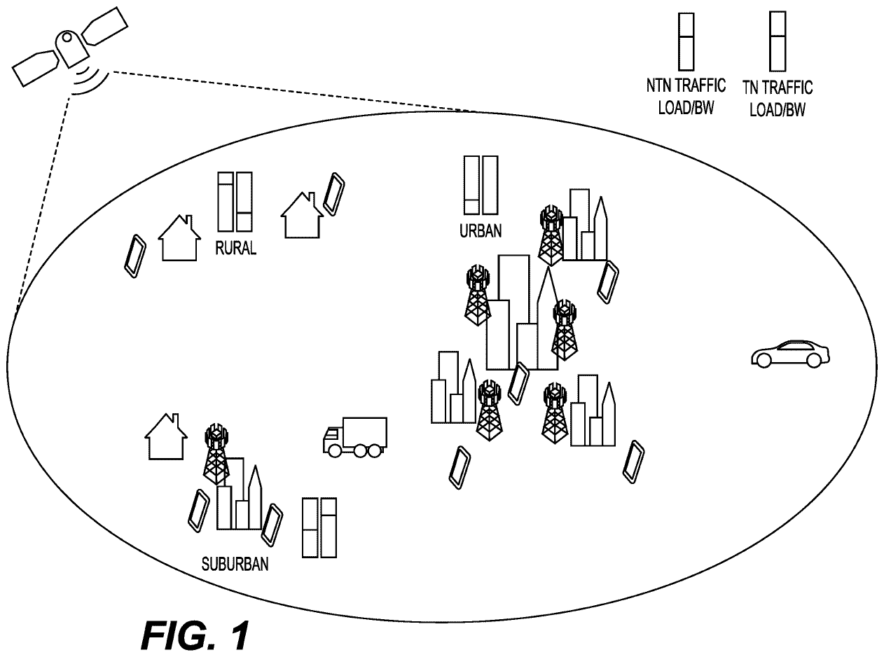

FIG. 1 illustrates a common scenario depicting varying usage rates of the non-terrestrial network (NTN) spectrum and the terrestrial network (TN) spectrum in different geographic locations. As shown in FIG. 1, in urban areas, there is a high demand for TN spectrum, while NTN spectrum utilization remains low. In suburban areas, NTN traffic load increases as TN traffic load decreases. In rural areas, there may be a lack of TN coverage, resulting in a shortage of NTN spectrum. Considering these disparities in spectrum utilization across different areas, it is desirable to allocate the spectrum resources in a coordinated manner so as to meet the specific demands of each geographic location and provide enhanced network services.

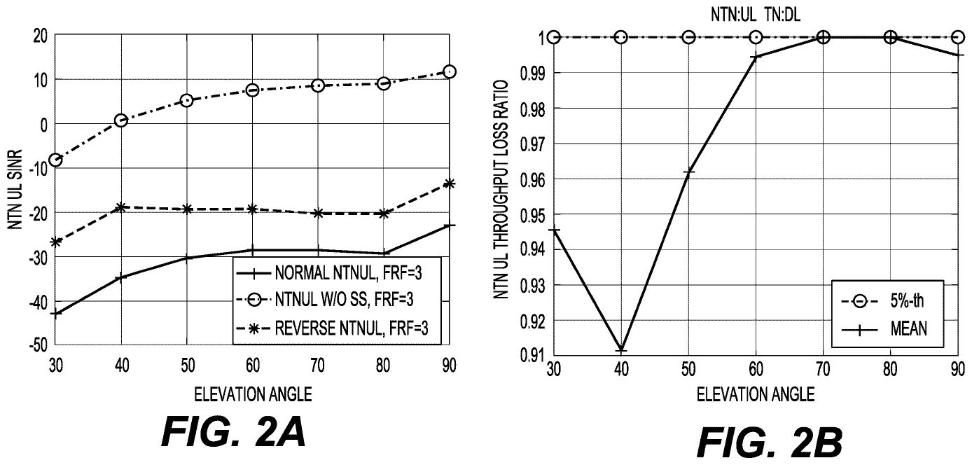

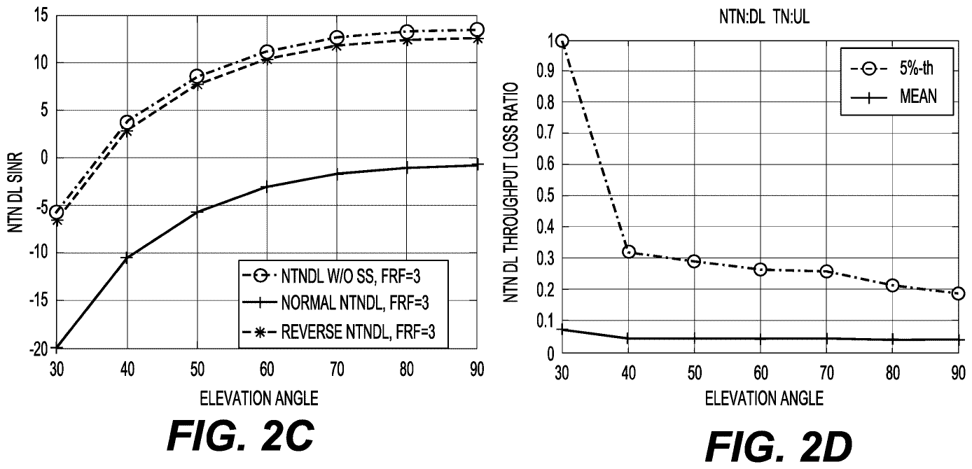

FIGS. 2A-2D show typical observations regarding the uplink (UL) and downlink (DL) performance of the NTN when encountering interference from TN base stations (BSs) and TN user equipments (UEs).

As can be seen from FIGS. 2A and 2B regarding NTN UL performance, the average throughput loss ratio exceeds 90%, indicating significant degradation. NTN UL operations are heavily affected when the signal-to-interference-plus-noise ratio (SINR) falls below-10 dB. As can be seen from FIGS. 2C and 2D regarding NTN DL performance, the average throughput loss ratio is less than 10%. However, the 5%-tile worst NTN UE experiences a throughput loss ratio larger than 20%. The root causes for these issues can be attributed to severe aggregated TN BS interference and severe aggregated TN UE interference. To provide a reliable network experience, it is necessary to mitigate the impact of such interference on the performance of NTN communications.

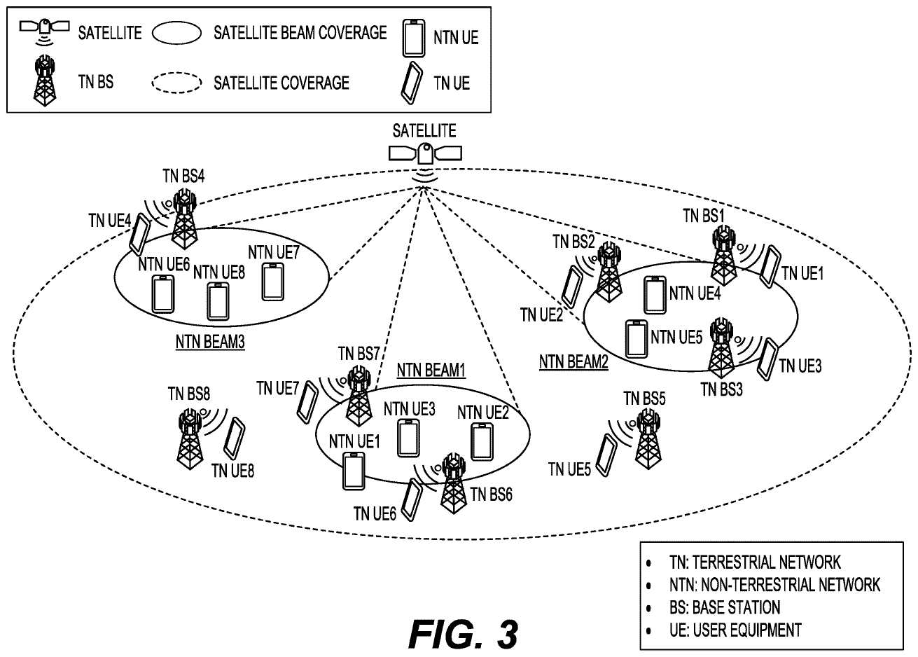

FIG. 3 illustrates a non-limiting example of the infrastructure of a coordinated TN-NTN framework, in accordance with embodiments of the disclosure. Multiple terrestrial network base stations (e.g., TN BSs 1-8) are strategically located within the satellite coverage represented by the dashed ellipse, serving a plurality of terrestrial network user equipments (e.g., TN UEs 1-8). Moreover, within the coverage areas of individual satellite beams (e.g., NTN cells or NTN beams 1-3), a plurality of non-terrestrial network user equipments (e.g., NTN UEs 1-8) can access wireless communication services provided by the non-terrestrial network.

By analyzing the Reference Signals Received Power (RSRP) (or the Reference Signals Received Quality (RSRQ)) in the NTN beam (or the NTN cell), the coverage of the NTN beam can be determined. This determination can be based on comparing the received RSRP or RSRQ at the satellite from the NTN UE in question (or at the NTN UE in question from the satellite) against a predefined threshold. If the measured values exceed this threshold, it indicates that the NTN UE is within the coverage of the NTN beam.

In accordance with embodiments of this disclosure, coordination is established between TN and NTN radio resources to optimize spectrum allocation, enhance coverage, and improve overall network performance. The radio resources assigned for the TN cells can partially overlap with the radio resources assigned for the NTN cells. This partial overlap between the radio resources can involve the frequency domain, the time domain, and/or the polarization direction, enabling efficient utilization and allocation of resources within the coordinated TN-NTN framework.

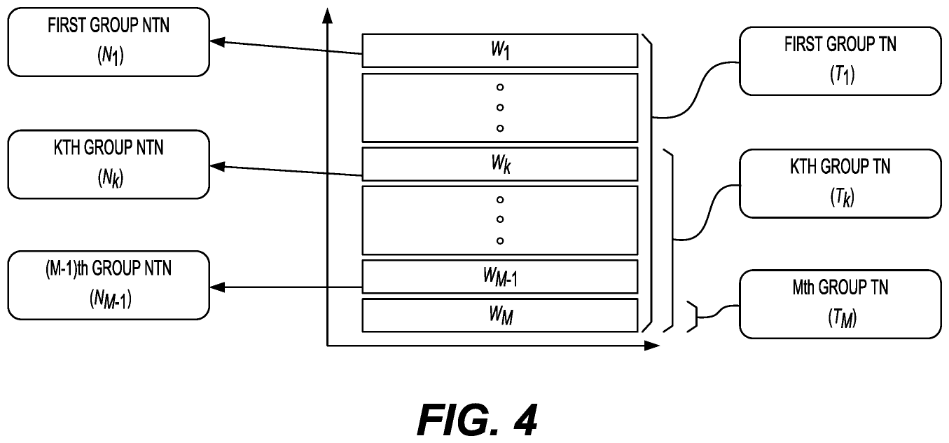

FIG. 4 presents a non-limiting example of a scheme for performing coordinated allocation of radio resources between NTN UEs and TN BSs, in accordance with embodiments of the disclosure.

According to one embodiment of the disclosure, based on a set of predefined threshold(s)

$$\{ {δ}_{1}^{N T N} , {δ}_{2}^{N T N} , … , {δ}_{M - 2}^{N T N} \} ,$$

the NIN UEs can be divided into (M−1) groups, i.e., {N₁, N₂, . . . , N_{M-1}}. The radio resources can be partitioned into M parts, W₁, W₂, . . . , W_{M}. Each of the (M−1) parts of the radio resources can be assigned to a specific group of the NTN UEs.

For example, as shown in FIG. 4, the first part W₁ of the radio resources can be assigned to the first group N₁ of the NTN UEs, the k-th part Wₖ of the radio resources can be assigned to the k-th group Nₖ of the NTN UEs, and the (M−1)-th part W_{M-1} of the radio resources is assigned to the (M−1)-th group N_{M-1} of the NTN UEs, where 1<k<M−1. Note that the M-th part W_{M} of the radio resources is exclusively reserved for TN BS usage, and thus is not assigned to any NTN UE group.

For example, the i-th part Wᵢ of the radio resources can be determined by

$${W}_{i} = ( W - {W}_{M} ) * \vert {N}_{i} \vert / ( sum ( \vert {N}_{1} \vert , \vert {N}_{2} \vert , … , \vert {N}_{M - 1} \vert ) ) ,$$

where |Nᵢ| denotes the number of the NTN UEs included in the i-th NTN UE group Nᵢ, and i=1, 2, . . . , M−1. Furthermore, each NTN UE in the group Nᵢ receives a portion of Wᵢ, denoted as bwᵢ, which is determined by

$${bw}_{i} = {W}_{i} / \vert {N}_{i} \vert .$$

Similarly, based on a set of predefined thresholds

$$\{ {δ}_{1}^{TN} , {δ}_{2}^{TN} , … , {δ}_{M - 1}^{TN} \} ) ,$$

the TN BSs can be divided into M groups, i.e., {T₁, T₂, . . . , T_{M}}. The sum of radio resources (Wₖ, Wₖ₊₁, . . . , W_{M}) can be assigned to the k-th TN BS group Tk, where 1≤k≤M.

Note that it is possible for some of the (M−1) NTN UE groups to be empty. For example, when M=4, the NTN UEs are divided into three groups: N1, N2, and N3. In this scenario, it is possible that only the groups N1 and N2 contain NTN UEs, while the group N3 does not have any NTN UEs. Similarly, some of the M TN BS groups can also be empty. For example, it is possible that only the groups T1, T2, and T4 have TN BSs, while the group T3 does not have any TN BSs.

In the above-described embodiment, the NTN UEs and TN BSs are grouped based on two sets of predefined thresholds. However, in another embodiment of the disclosure, grouping can be accomplished using an objective function.

Specifically, the maximum number (i.e., M) of the radio resource groups and the unit resources (i.e., {bw₁, bw₂, . . . , bw_{M-1}}) for each of the radio resource groups W₁, W₂, . . . , W_{M-1} can be pre-determined, and an objective function can be pre-defined.

To maximize the objective function, two sets of threshold parameters can be determined. The first set of threshold parameters

$$\{ {δ}_{1}^{NTN} , {δ}_{2}^{NTN} , … , {δ}_{M - 2}^{NTN} \}$$

is used for grouping the NTN UEs, while the second set of threshold parameters

$$\{ {δ}_{1}^{TN} , {δ}_{2}^{TN} , … , {δ}_{M - 1}^{TN} \}$$

is used for grouping the TN BSs.

Using the first set of threshold parameters

$$\{ {δ}_{1}^{NTN} , {δ}_{2}^{NTN} , … , {δ}_{M - 2}^{NTN} \} ,$$

the NTN UEs can be divided into (M−1) groups, i.e., {N₁, N₂, . . . , N_{M-1}}. Similarly, using the second set of threshold parameters

$$\{ {δ}_{1}^{TN} , {δ}_{2}^{TN} , … , {δ}_{M - 1}^{TN} \} ,$$

the TN BSs can be grouped into M groups, i.e., {T₁, T₂, . . . , T_{M}}.

As mentioned previously, it is possible for some of the (M−1) NTN UE groups to be empty. Similarly, some of the M TN BS groups can also be empty.

Based on the number of NTN UEs in each NTN UE group and the unit resource for each radio resource group, the total radio resources W can be partitioned into M parts, {W₁, W₂, . . . , W_{M}}, where Wᵢ=|Nᵢ|*bwᵢ, for i=1, 2, . . . , M−1, and W_{M}=W−sum(W₁, W₂, . . . . W_{M-1}).

The k-th part Wₖ of the radio resources can be assigned to the k-th NTN UE group Nₖ, where 1≤k≤M−1. For i=1, 2, . . . , M−1, each NTN UE in the i-th group Nᵢ is allocated a portion of the radio resource, which has a size equal to bwᵢ. The sum of radio resources (Wₖ, Wₖ₊₁, . . . , W_{M}) can be assigned to the k-th TN BS group Tk, where 1≤k≤M.

Note that although in the above examples, NTN UEs are divided into (M−1) groups, other numbers of NTN UE groups are possible. For instance, M, (M−2), or (M−3) NTN UE groups can be used without departing from the spirit and scope of this disclosure.

The objective function can be formulated in various ways. Here, four non-limiting examples of the objective function are provided. Those skilled in the art can recognize that other forms of the objective function are also possible.
Example 1: (sum of TN BSs' throughput in group T₁, T₂, . . . , T_{M})*(sum of NTN UEs' throughput in group N₁, N₂, . . . , N_{M-1}).
Example 2: (1−α)*(sum of TN BSs' throughput in group T₁, T₂, . . . , T_{M})+α*(sum of NTN UEs' throughput in group N₁, N₂, . . . , N_{M-1}), where α∈(0,1) is a weighted factor.
Example 3: (sum of TN BSs' obtained bandwidth in group T₁, T₂, . . . , T_{M})*(sum of NTN UEs' throughput in group N₁, N₂, . . . , N_{M-1}).
Example 4: (1−α)*(sum of TN BSs' obtained bandwidth in group T₁, T₂, . . . , T_{M})+α*(sum of NTN UEs' throughput in group N₁, N₂, . . . , N_{M-1}), where α∈(0,1) is a weighted factor.

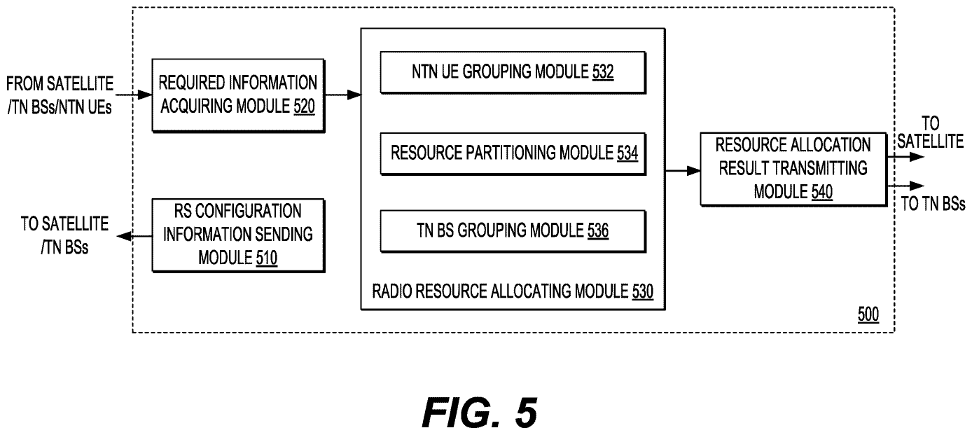

FIG. 5 shows a block diagram of an apparatus 500 for performing the coordinated allocation of radio resources between the NTN UEs and the TN BSs, in accordance with embodiments of the disclosure. The apparatus 500 includes an RS configuration information sending module 510, a required information acquiring module 520, a radio resource allocating module 530, and a resource allocation result transmitting module 540.

The RS Configuration Information Sending Module 510 sends reference signal (RS) configuration information to the satellite and the TN BSs. The RS configuration information defines how a reference signal that is to be used for acquiring the information necessary to allocate radio resources is transmitted. For example, the RS configuration information specifies the resource blocks on which the reference signal should be transmitted.

The required information acquiring module 520 acquires, from the satellite, the TN BSs, and/or the NTN UEs, information that is required to make radio resource allocation decisions. Two examples illustrating the specifics of this acquired information will be described below.

Based on the information acquired by the required information acquiring module 520, the radio resource allocating module 530 determines the optimal allocation of radio resources between the TN BS groups and the NTN UE groups. Consequently, the radio resource allocating module 530 generates resource allocation results. The radio resource allocating module 530 can include three sub-modules: an NTN UE grouping module 532, a resource partitioning module 534, and a TN BS grouping module 536. These sub-modules can handle NTN UE grouping, radio resource partitioning, and TN BS grouping, respectively.

The resource allocation result transmitting module 540 receives the resource allocation results generated by the radio resource allocation module 530, and transmits them to the satellite and the TN BSs.

For instance, the resource allocation results can be transmitted via unicast communication. In cases where the radio resources are partitioned in the frequency domain, the allocated frequency ranges and their corresponding valid duration can be transmitted to the respective TN BSs and the satellite.

Upon receiving the resource allocation results, the TN BSs and the satellite can configure or de-configure cells based on the received information. Additionally, they can broadcast cell information and deconfiguration details to the UEs within the cells. This ensures that the UEs are informed of the cell configuration changes.

Once the UEs receive the cell configuration or deconfiguration information, they can acknowledge its receipt by returning an acknowledgement message. Then, the UEs can access or leave the cell as required, aligning their behavior with the updated configuration.

In FIG. 5, the modules 510, 520, 530, and 540 are depicted as integrated within a single apparatus 500, which can be positioned at various locations within the TN-NTN framework. These locations include, but are not limited to, TN BSs and the satellite. It should be noted that the functionality of the apparatus 500 can also be implemented through separate function modules distributed across the TN-NTN framework.

For instance, a server can be responsible for collecting the information necessary to determine radio resource allocation, while a controller can decide resource allocation based on the information collected by the server. Note that this is merely a non-restrictive example, as those skilled in the art can recognize that there are various alternative approaches to accomplish the radio resource allocation.

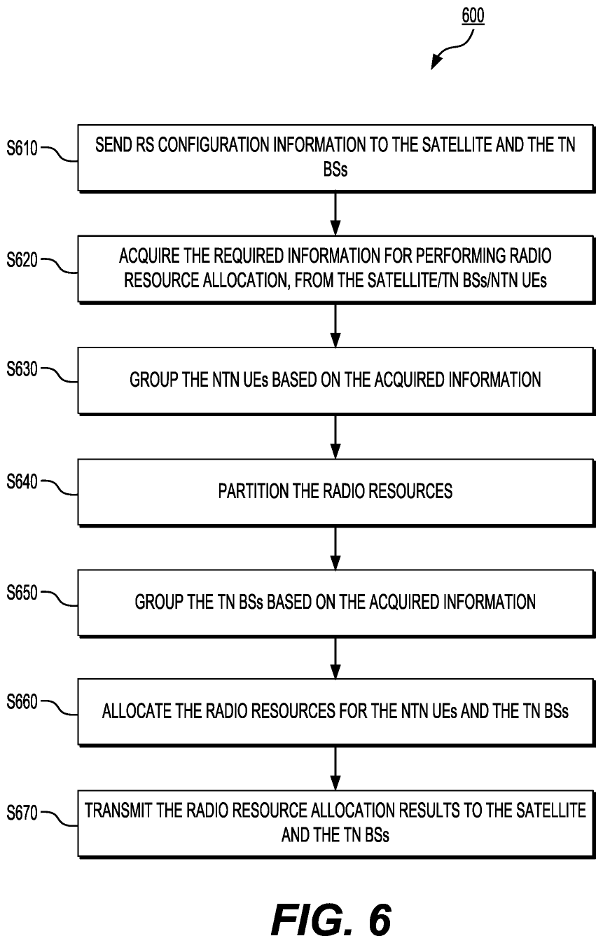

FIG. 6 shows a flow chart of a process 600 for performing the coordinated allocation of radio resources between NTN UEs and TN BSs, in accordance with embodiments of the disclosure. The process 600 starts with step S610, where the RS configuration information is sent to the satellite and the TN BSs.

In step S620, the required information for performing the radio resource allocation is acquired from the satellite, NTN UEs, and/or TN BSs.

In step S630, using the set of thresholds

$$\{ {δ}_{1}^{NTN} , {δ}_{2}^{NTN} , … , {δ}_{M - 2}^{NTN} \} ,$$

the NIN UEs are divided into different groups based on the acquired information. As described above, the set of thresholds can be predefined for the TN-NTN framework, or determined using an objective function.

In step S640, the radio resources can be partitioned. In step S650, using the set of thresholds

$$\{ {δ}_{1}^{TN} , {δ}_{2}^{TN} , … , {δ}_{M - 1}^{TN} \} ) ,$$

the TN BSs can be grouped. In step S660, the radio resources can be allocated for the NTN UE groups and the TN BS groups in a manner described with reference to FIG. 4. In step S670, the radio resource allocation results can be transmitted to the satellite and the TN BSs.

In the following two examples, further details of the radio resource allocation process are provided.

### Example 1

As described with reference to FIGS. 5-6, the process for allocating radio resources between TN BSs and NTN UEs can include the following primary Procedures 1-3.

### (1) Procedure 1: Acquiring the Required Information

The required information can include: (i) information that facilitates to determine the NTN UE groups, and (ii) information that facilitates to determine the TN BS groups.

For instance, the information that facilitates to determine the NTN UE groups can include: (a) the received RSRP at the satellite from each NTN UE in the NTN beam, and (b) the received RSRP at each NTN UE from the satellite in the NTN beam, etc.

The information that facilitates to determine the TN BS groups can include: (a) a coupling loss, which can be defined as the path loss minus the transmitter's and the receiver's antenna gain, of each TN BS to the satellite, where the coupling loss can be inferred from a satellite reference signal received at the TN BS; (b) the coupling loss of each TN BS to the satellite, where the coupling loss can be inferred from a TN BS reference signal received at the satellite; (c) the coupling loss of each TN BS to the NTN UEs, where the coupling loss can be inferred from the NTN UEs' reference signal received at the TN BS; (d) the coupling loss of each TN BS to the NTN UEs, where the coupling loss can be inferred from the TN BS's reference signal received at the NTN UEs, for example.

### (2) Procedure 2: Grouping the NTN UEs, Grouping the TN BSs, Partitioning the Radio Resources, and Allocating the Radio Resources to the NTN UEs and the TN BSs

As described with reference to FIG. 4, the NTN UEs in each NTN beam can be divided into (M−1) NTN UE groups, the radio resources can be partitioned into M non-overlapping radio resource parts; and the TN BSs in the satellite's coverage can be divided into M TN BS groups. The k-th radio resource part can be allocated to the k-th NTN UE group, where 1≤k≤M−1. The sum of the k-th to M-th radio resource parts can be allocated to the k-th TN BS group, where 1≤k≤M.

(A) Procedure 2-1: Dividing the NTN UEs in Each NTN Beam into (M−1) NTN UE Groups

According to one embodiment, the NTN UEs can be classified into M−1 groups, based on the received RSRP at the satellite. For example, the satellite can measure the received power of a UL signal (e.g., Sounding reference signal (SRS), preamble, Physical Uplink Control Channel (PUCCH), Physical Uplink Shared Channel (PUSCH), etc.) from the NTN UEs in the beam. Then, the NTN UE groups can be determined based on the individual received UL signal power and the predefined threshold set

$$( e . g . , \{ {δ}_{1}^{NTN} , {δ}_{2}^{NTN} , … , {δ}_{M - 2}^{NTN} \} ) .$$

For instance, with M=4, three NTN UE groups can be obtained, where

$${N}_{1} = \{ NTN UE id \vert the received NTN UL signal power \leq {δ}_{1}^{N T N} \} ,$$

$${N}_{2} = \{ NTN UE id \vert {δ}_{1}^{N T N} < the received NTN UL signal power \leq {δ}_{2}^{N T N} \} , and$$

$${N}_{3} = \{ NTN UE id \vert {δ}_{2}^{N T N} < the received NTN UL signal power \} .$$

According to an alternative embodiment, the NTN UEs can be classified into M−1 groups, based on the received RSRP at the NTN UEs. For example, the NTN UEs in the beam measures the received power of a DL signal (e.g., Synchronization Signal Block (SSB), Reference signal (RS), Channel State Information Reference Signal (CSI-RS), Tracking reference signaling (TRS), Physical Downlink Control Channel (PDCCH), Physical Downlink Shared Channel (PDSCH), etc.) from the satellite. Then, the NTN UE groups can be determined based on the individual received DL signal power and the predefined threshold set

$$( e . g . , \{ {δ}_{1}^{NTN} , {δ}_{2}^{NTN} , … , {δ}_{M - 2}^{NTN} \} ) .$$

For instance, with M=4, three NTN UE groups can be obtained, where

$${N}_{1} = \{ NTN UE id \vert the received NTN DL signal power \leq {δ}_{1}^{N T N} \} ,$$

$${N}_{2} = \{ NTN UE id \vert {δ}_{1}^{N T N} < the received NTN DL signal power \leq {δ}_{2}^{N T N} \} , and$$

$${N}_{3} = \{ NTN UE id \vert {δ}_{2}^{N T N} < the received NTN DL signal power \} .$$

(B) Procedure 2-2: Partitioning the Radio Resources into M Non-Overlapping Radio Resource Parts

Partitioning of the radio resources can be performed across various domains, including but not limited to the frequency domain, the time domain, and the polarization direction.

For example, in the frequency domain, the radio resources W can be partitioned according to the number of NTN UEs in each NTN UE group. For a part Wᵢ with i=1, 2, . . . . M−1, Wᵢ=(W−W_{M})*|Nᵢ|/(sum(|N₁|, |N₂|, . . . , |N_{M-1}|)), where the part W_{M} is exclusively reserved for TN BS usage.

As another example, the radio resources W can be partitioned in the time domain, according to the number of NTN UEs in each NTN UE group. For a part Wᵢ with i=1, 2, . . . . M−1, Wᵢ=(W−W_{M})*|Nᵢ|/(sum(|N₁|, |N₂|, . . . , |N_{M-1}|)), where W_{M} is the part exclusively allocated for TN BS usage.

(C) Procedure 2-3: Grouping TN BS(s) in the Satellite's Coverage into M TN BS Groups

According to one embodiment, the TN BSs can be classified into M groups, based on the coupling loss from each TN BS to the NTN beam of the satellite. For example, the coupling loss of each TN BS to the NTN beam of the satellite can be inferred from the satellite reference signal received at the TN BS, or the TN BS reference signal received at the satellite. Then, the TN BS groups can be determined based on the individual coupling loss from the TN BSs to the NTN beam of the satellite and the predefined threshold set

$$( e . g . , \{ {δ}_{1}^{T N} , {δ}_{2}^{T N} , … , {δ}_{M - 1}^{T N} \} ) .$$

For instance, with M=4, four TN BS groups can be obtained, where

$${T}_{1} = \{ TN BS id \vert the coupling loss from the TN BS to the NTN beam of the satellite \leq {δ}_{1}^{TN} \} ,$$

$${T}_{2} = \{ TN BS id \vert {δ}_{1}^{TN} < the coupling loss from the TN BS to the NTN beam of the satellite \leq {δ}_{2}^{TN} \} ,$$

$${T}_{3} = \{ TN BS id \vert {δ}_{2}^{T N} < the coupling loss from the TN BS to the NTN beam of the satellite \leq {δ}_{3}^{TN} \} , and$$

$${T}_{4} = \{ TN BS id \vert {δ}_{3}^{T N} < the coupling loss from the TN BS to the NTN beam of the satellite \} .$$

According to an alternative embodiment, the TN BSs can be classified into M groups, based on the coupling loss from each TN BS to the NTN UEs in the beam. For example, the coupling loss of each TN BS to an NTN UE can be inferred from the NTN UEs' reference signal received at the TN BS, or the TN BS's reference signal received at the NTN UEs, etc. Then, the TN BS groups can be determined based on the individual coupling loss from the TN BS to the NTN UEs in the beam and the predefined threshold set

$$( e . g . , \{ {δ}_{1}^{T N} , {δ}_{2}^{T N} , … , {δ}_{M - 1}^{T N} \} ) .$$

For instance, with M=4, four TN BS groups can be obtained, where

$${T}_{1} = \{ TN BS id \vert the coupling loss from the TN BS to a selected one of the NTN UEs in the beam \leq {δ}_{1}^{TN} \} ,$$

$${T}_{2} = \{ TN BS id \vert {δ}_{1}^{TN} < the coupling loss from the TN BS to the selected NTN UE in the beam \leq {δ}_{2}^{TN} \} ,$$

$${T}_{3} = \{ TN BS id \vert {δ}_{2}^{TN} < the coupling loss from the TN BS to the selected NTN UE in the beam \leq {δ}_{3}^{TN} \} , and$$

$${T}_{4} = \{ TN BS id \vert {δ}_{3}^{TN} < the coupling loss from the TN BS to the selected NTN UE in the beam \} .$$

The selection of the NTN UE can be based on various predefined criteria.

In another example with M=4,

$${T}_{1} = \{ TN BS id \vert the average coupling loss from the TN BS to the NTN UEs in the beam \leq {δ}_{1}^{TN} \} ,$$

$${T}_{2} = \{ TN BS id \vert {δ}_{1}^{T N} < the average coupling loss from the TN BS to the NTN UEs in the beam \leq {δ}_{2}^{TN} \} ,$$

$${T}_{3} = \{ TN BS id \vert {δ}_{2}^{T N} < the average coupling loss from the TN BS to the NTN UEs in the beam \leq {δ}_{3}^{T N} \} , and$$

$${T}_{4} = \{ TN BS id \vert {δ}_{3}^{T N} < the average coupling loss from the TN BS to the NTN UEs in the beam \} .$$

In another example with

$$M = 4 , {T}_{1} = \{ TN BS id \vert the maximum coupling loss from the TN BS to the NTN UEs in the beam \leq {δ}_{1}^{TN} \} , {T}_{2} = \{ TN BS id \vert {δ}_{1}^{TN} < the maximum coupling loss from the TN BS to the NTN UEs in the beam \leq {δ}_{2}^{TN} \} , {T}_{3} = \{ TN BS id \vert {δ}_{2}^{TN} < the maximum coupling loss from the TN BS to the NTN UEs in the beam \leq {δ}_{3}^{TN} \} , and {T}_{4} = \{ TN BS id \vert {δ}_{3}^{TN} < the maximum coupling loss from the TN BS to the NTN UEs in the beam \} .$$

In another example with

$$M = 4 , {T}_{1} = \{ TN BS id \vert the median coupling loss from the TN BS to the NTN UEs in the beam \leq {δ}_{1}^{TN} \} , {T}_{2} = \{ TN BS id \vert {δ}_{1}^{TN} < the median coupling loss from the TN BS to the NTN UEs in the beam \leq {δ}_{2}^{TN} \} , {T}_{3} = \{ TN BS id \vert {δ}_{2}^{TN} < the median coupling loss from the TN BS to the NTN UEs in the beam \leq {δ}_{3}^{TN} \} , and {T}_{4} = \{ TN BS id \vert {δ}_{3}^{TN} < the median coupling loss from the TN BS to the NTN UEs in the beam \} .$$

### (D) Procedure 2-4: Allocating the Radio Resource Parts

In this procedure, the k-th radio resource part can be allocated to the corresponding k-th NTN UE group. Specifically, the ratio resource part Wᵢ is assigned to the NTN UE group Nᵢ, where i=1, 2, . . . , M−1. The radio resource assigned to each NTN UE in the group Nᵢ is determined by bwᵢ=Wᵢ/|Nᵢ|.

Additionally, the sum of the radio resource parts from Wₖ to W_{M} is assigned to the k-th TN BS group. In other words, the resource parts, Wₖ+Wₖ₊₁+ . . . +W_{M}, are assigned to the k-th TN BS group, where 1≤k≤M.

### (3) Procedure 3: Sending Resource Allocation Results to the TN BSs and the Satellite.

For example, the information regarding bwᵢ, and Wᵢ for each NTN UE within the NTN UE group Nᵢ can be sent to the satellite, where i=1, 2, . . . , M−1. Similarly, the information regarding Wᵢ, Wᵢ+1, . . . , W_{M} can be sent to each TN BS within the TN BS group Ti, where i=1, 2, . . . , M.

### Example 2

In this example, the process for allocating radio resources between TN BSs and NTN UEs mainly includes procedures 1-3 as well. Since Procedures 1 and 3 are the same as those described in Example 1, the description of these procedures is omitted.

### (A) Procedure 2-1: Determining the Threshold Parameter Sets

In this procedure, two sets of threshold parameters are determined to maximize the objective function. The first set of threshold parameters

$$\{ {δ}_{1}^{N T N} , {δ}_{2}^{N T N} , … , {δ}_{M - 2}^{N T N} \}$$

is used for grouping the NTN UEs, while the second set of threshold parameters

$$\{ {δ}_{1}^{TN} , {δ}_{2}^{TN} , … , {δ}_{M - 1}^{TN} \}$$

is used for grouping the TN BSs.

For example, the objective function can be designed as (sum of TN BSs' obtained bandwidth in group T₁, . . . . T_{M})*(sum of NTN UEs' throughput in group N₁, . . . . N_{M-1}), which can be given by:

$${max}_{\text{?}} ( {\sum }_{\text{?}} {\sum }_{k = 1}^{M} {w}_{k} + {\sum }_{j = 2}^{M - 1} {\sum }_{\text{?}} {\sum }_{k = j}^{M} {w}_{k} + {\sum }_{\text{?}} {w}_{M} ) ( {b}_{1}^{N} {\sum }_{\text{?}} {Γ}_{k}^{{N}_{1}} ( {δ}_{1}^{TN} ) + {\sum }_{j = 2}^{M - 2} {b}_{j}^{N} {\sum }_{\text{?}} {Γ}_{k}^{{N}_{j}} ( {δ}_{1}^{TN} , … , {δ}_{j}^{TN} ) + {b}_{M - 1}^{N} {\sum }_{\text{?}} {Γ}_{b}^{{N}_{M - 1}} ( {δ}_{1}^{TN} , … , {δ}_{M - 1}^{TN} ) )$$

$$\text{?} \text{indicates text missing or illegible when filed}$$

where

$${Γ}_{k}^{{N}_{j}}$$

denotes the log(1+SINR) of an NTN UE k in the group Nj.

Other examples of the objective function can include but not limited to:
(sum of TN BSs' throughput in group T₁, . . . . T_{M})*(sum of NTN UEs' throughput in group N₁, . . . . N_{M-1}),
(1−α)*(sum of TN BSs' throughput in group T₁, . . . . T_{M})+α*(sum of NTN UEs' throughput in group N₁, . . . . N_{M-1}), where α∈(0,1) is a weighted factor, and
(1−α)*(sum of TN BSs' obtained bandwidth in group T₁, . . . . T_{M})+α*(sum of NTN UEs' throughput in group N₁, . . . . N_{M-1}), where α∈(0,1) is a weighted factor.
   (B) Procedure 2-2: Dividing the NTN UEs in Each NTN Beam into (M−1) Groups

According to one embodiment, the NTN UEs can be classified into M−1 groups, based on the received RSRP at the satellite. For example, the satellite can measure the received power of a UL signal (e.g., SRS, preamble, PUCCH, PUSCH, etc.) from the NTN UEs in the beam. Then, the NTN UE groups can be determined based on the individual received UL signal power and the threshold parameter set

$$( e . g . , \{ {δ}_{1}^{N T N} , {δ}_{2}^{N T N} , … , {δ}_{M - 2}^{N T N} \} )$$

obtained in Procedure 2-1.

For instance, with M=4, three NTN UE groups can be obtained, where

$${N}_{1} = \{ NTN UE id \vert the received NTN UL signal power \leq {δ}_{1}^{NTN} \} , {N}_{2} = \{ NTN UE id \vert {δ}_{1}^{NTN} < the received NTN UL signal power \leq {δ}_{2}^{NTN} \} , and {N}_{3} = \{ NTN UE id \vert {δ}_{2}^{NTN} < the received NTN UL signal power \} .$$

According to an alternative embodiment, the NTN UEs can be classified into M−1 groups, based on the received RSRP at the NTN UEs. For example, the NTN UE in the beam measures the received power of a DL signal (e.g., SSB, RS, CSI-RS, TRS, PDCCH, PDSCH, etc.) from the satellite. Then, the NTN UE groups can be determined based on the individual received DL signal power and the threshold parameter set

$$( e . g . , \{ {δ}_{1}^{N T N} , {δ}_{2}^{N T N} , … , {δ}_{M - 2}^{N T N} \} )$$

obtained in Procedure 2-1.

For instance, with M=4, three NTN UE groups can be obtained, where

$${N}_{1} = \{ NTN UE id \vert the received NTN DL signal power \leq {δ}_{1}^{NTN} \} , {N}_{2} = \{ NTN UE id \vert {δ}_{1}^{NTN} < the received NTN DL signal power \leq {δ}_{2}^{NTN} \} , and {N}_{3} = \{ NTN UE id \vert {δ}_{2}^{NTN} < the received NTN DL signal power \} .$$

Procedure 2-3: Partitioning the Radio Resources into M Non-Overlapping Radio Resource Parts

Partitioning of the radio resources can be performed across various domains, including but not limited to the frequency domain, the time domain, and the polarization direction.

For example, in the frequency domain, the radio resources W can be partitioned according to the number of NTN UEs in each NTN UE group. For a part Wᵢ with i=1, 2, . . . . M−1, Wᵢ=|Nᵢ|*bwᵢ; or Wᵢ=(W−W_{M})*|Nᵢ|/(sum(|N₁|, |N₂|, . . . , |N_{M-1}|)).

As another example, the radio resources W can be partitioned in the time domain, according to the number of NTN UEs in each NTN UE group. For a part Wᵢ with i=1, 2, . . . . M−1, Wᵢ=|Nᵢ|*bwᵢ; or Wᵢ=(W−W_{M})*|Nᵢ|/(sum(|N₁|, |N₂|, . . . , |N_{M-1}|)).

In both examples above, the part W_{M} is exclusively reserved for TN BS usage. For instance, the part W_{M} can be predetermined, or determined by W_{M}=the total radio resources−sum(W₁+ . . . +W_{M-1}).

(D) Procedure 2-4: Grouping TN BSs in the Satellite's Coverage into M TN BS Groups

According to one embodiment, the TN BSs can be classified into M groups, based on the coupling loss from each TN BS to the NTN beam of the satellite. For example, the coupling loss of each TN BS to the NTN beam of the satellite can be inferred from the satellite reference signal received at the TN BS, or the TN BS reference signal received at the satellite. Then, the TN BS groups can be determined based on the individual coupling loss from the TN BSs to the NTN beam of the satellite and the threshold parameter set

$$( e . g . , \{ {δ}_{1}^{TN} , {δ}_{2}^{TN} , … , {δ}_{M - 1}^{TN} \} )$$

obtained in Procedure 2-1.

For instance, with M=4, four TN BS groups can be obtained, where

$${T}_{1} = \{ TN BS id \vert the coupling loss from the TN BS to the NTN beam of the satellite \leq {δ}_{1}^{NTN} \} , {T}_{2} = \{ TN BS id \vert {δ}_{1}^{TN} < the coupling loss from the TN BS to the NTN beam of the satellite \leq {δ}_{2}^{NTN} \} , {T}_{3} = \{ TN BS id \vert {δ}_{2}^{TN} < the coupling loss from the TN BS to the NTN beam of the satellite \leq {δ}_{3}^{NTN} \} , and {T}_{4} = \{ TN BS id \vert {δ}_{3}^{TN} < the coupling loss from the TN BS to the NTN beam of the satellite \} .$$

According to an alternative embodiment, the TN BSs can be classified into M groups, based on the coupling loss from each TN BS to the NTN UEs in the beam. For example, the coupling loss of each TN BS to an NTN UE can be inferred from the NTN UEs' reference signal received at the TN BS, or the TN BS's reference signal received at the NTN UEs, etc. Then, the TN BS groups can be determined based on the individual coupling loss from the TN BS to the NTN UEs in the beam and the threshold parameter set

$$( e . g . , \{ {δ}_{1}^{TN} , {δ}_{2}^{TN} , … , {δ}_{M - 1}^{TN} \} )$$

obtained in Procedure 2-1.

For instance, with M=4, four TN BS groups can be obtained, where

$${T}_{1} = \{ TN BS id \vert the coupling loss from the TN BS to a selected on e of the NTN UEs in the beam \leq {δ}_{1}^{TN} \} , {T}_{2} = \{ TN BS id \vert {δ}_{1}^{TN} < the coupling loss from the TN BS to the selected NTN UE in the beam \leq {δ}_{2}^{TN} \} , {T}_{3} = \{ TN BS id \vert {δ}_{2}^{TN} < the coupling loss from the TN BS to the selected NTN UEs in the beam \leq {δ}_{3}^{TN} \} , and {T}_{4} = \{ TN BS id \vert {δ}_{3}^{TN} < the coupling loss from the TN BS to the selected NTN UEs in the beam \} .$$

One skilled in the art can recognize that various predefined criteria can be applied to select the NTN UE.

In another example with M=4,

$${T}_{1} = \{ TN BS id \vert the average coupling loss from the TN BS to the NTN UEs in the beam \leq {δ}_{1}^{TN} \} , {T}_{2} = \{ TN BS id \vert {δ}_{1}^{TN} < the average coupling loss from the TN BS to the NTN UEs in the beam \leq {δ}_{2}^{TN} \} , {T}_{3} = \{ TN BS id \vert {δ}_{2}^{TN} < the average coupling loss from the TN BS to the NTN UEs in the beam \leq {δ}_{3}^{TN} \} , and {T}_{4} = \{ TN BS id \vert {δ}_{3}^{TN} < the average coupling loss from the TN BS to the NTN UEs in the beam \} .$$

In another example with M=4,

$${T}_{1} = \{ TN BS id \vert the maximum coupling loss from the TN BS to the NTN UEs in the beam \leq {δ}_{1}^{NTN} \} , {T}_{2} = \{ TN BS id \vert {δ}_{1}^{TN} < the maximum coupling loss from the TN BS to the NTN UEs in the beam \leq {δ}_{2}^{NTN} \} , {T}_{3} = \{ TN BS id \vert {δ}_{2}^{TN} < the maximum coupling loss from the TN BS to the NTN UEs in the beam \leq {δ}_{3}^{NTN} \} , and {T}_{4} = \{ TN BS id \vert {δ}_{3}^{TN} < the maximum coupling loss from the TN BS to the NTN UEs in the beam \} .$$

In another example with M=4,

$${T}_{1} = \{ TN BS id \vert the median coupling loss from the TN BS to the NTN UEs in the beam \leq {δ}_{1}^{TN} \} , {T}_{2} = \{ TN BS id \vert {δ}_{1}^{TN} < the median coupling loss from the TN BS to the NTN UEs in the beam \leq {δ}_{2}^{TN} \} , {T}_{3} = \{ TN BS id \vert {δ}_{2}^{TN} < the median coupling loss from the TN BS to the NTN UEs in the beam \leq {δ}_{3}^{TN} \} , and {T}_{4} = \{ TN BS id \vert {δ}_{3}^{TN} < the median coupling loss from the TN BS to the NTN UEs in the beam \} .$$

### (E) Procedure 2-5: Allocating the Radio Resource Parts

In this procedure, the k-th radio resource part can be allocated to the corresponding k-th NTN UE group. Specifically, the ratio resource part Wᵢ is assigned to the NTN UE group Nᵢ, where i=1, 2, . . . , M−1. The radio resource assigned to each NTN UE in the group Nᵢ is determined by bwᵢ=Wᵢ/|Nᵢ|.

Additionally, the sum of the radio resource parts from Wₖ to W_{M} is assigned to the k-th TN BS group. In other words, the resource parts, Wₖ+Wₖ₊₁+ . . . +W_{M}, are assigned to the k-th TN BS group, where 1≤k≤M.

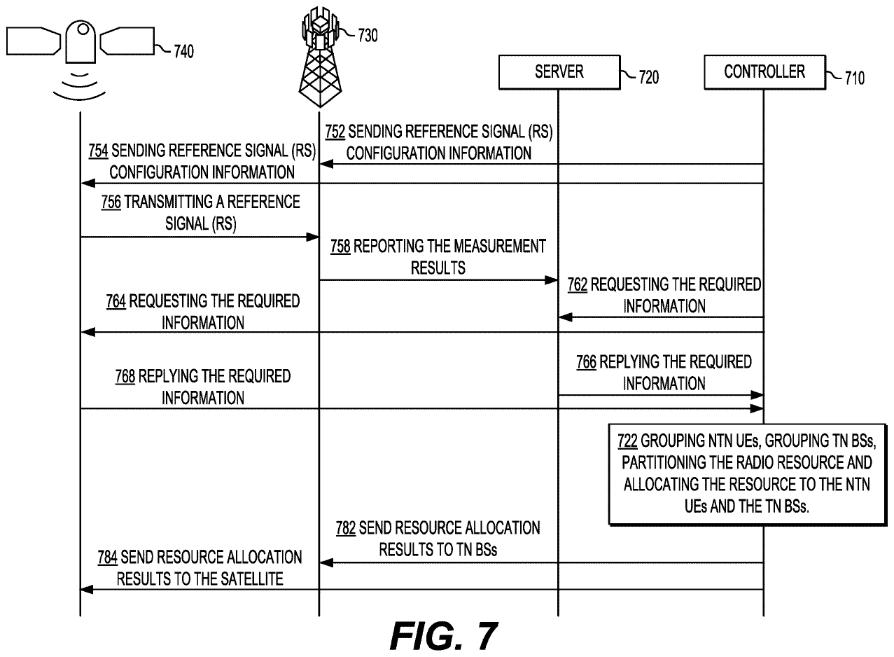

FIG. 7 shows a signal flow chart depicting the interaction between the resource allocation apparatus, the satellite, and an exemplary TN BS, in accordance with embodiments of the disclosure. As previously mentioned, the resource allocation apparatus can be implemented as a single unit or divided into separate modules. In the scenario shown in FIG. 7, a controller 710 and a server 720 collaborate to perform radio resource allocation. The server 720 is capable of acquiring the necessary information for resource allocation from the TN BSs, the satellite, and/or the NTN UEs (not shown in FIG. 7). The controller 710 can use the information collected by the server 720 (and sent directly from the satellite 740) to decide how to allocate the radio resources. Only one TN BS 730 is exemplified here, but there can be a plurality of TN BSs in practice.

At 752 and 754, the controller 710 can send reference signal (RS) configuration information to the TN BS 730 and the satellite 740. Then, the satellite 740 generates a reference signal based on the RS configuration information, and sends it at 756 to the TN BS 730. The TN BS can measure the reference signal based on the RS configuration information and report the measurement results at 758 to the server 720.

At 762, the controller 710 can send request messages to the server 720 and the satellite 740 to obtain information. At 766 and 768, the server 720 and the satellite 740 can respond to the controller 710 by sending response messages carrying the requested information. For example, the information sent at 766 can be the satellite reference signal measured at the TN BS 730, while the information sent at 768 can be the received RSRP at the satellite 740 from each NTN UE (not shown in FIG. 7) in the NTN beam.

At 772, the controller 710 can decide how to allocate the radio resources by grouping the NTN UEs, partitioning the radio resources, grouping the TN BSs, and assigning the radio resources between the NTN UEs and TN BSs. As described earlier, the NTN UEs in each NTN beam can be divided into (M−1) groups. The radio resources can be partitioned into M non-overlapping parts. The TN BSs in the satellite's coverage can be divided into M groups. The k-th part of the radio resources can be allocated to the k-th NTN UE group, where k ranges from 1 to M−1. The sum of the (k-th to M-th) radio resources to the kth TN BS group, where k ranges from 1 to M.

At 782 and 784, the controller 710 can transmit the resource allocation results to the TN BS 730 and the satellite 740 for implementation.

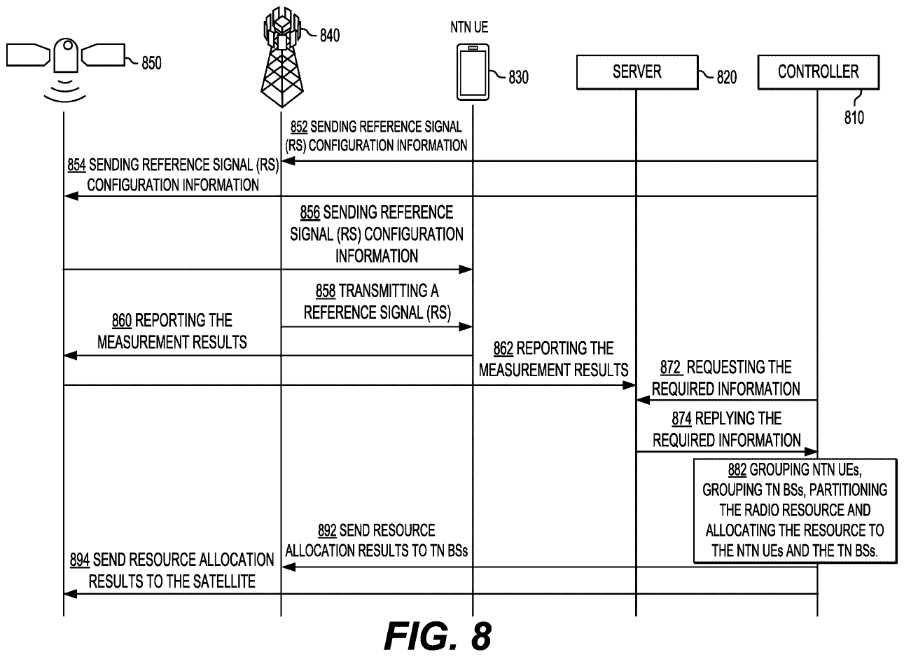

FIG. 8 shows a signal flow chart depicting the interaction between the resource allocation apparatus, the satellite, an exemplary TN BS, and an exemplary NTN UE, in accordance with embodiments of the disclosure. Again, in the scenario shown in FIG. 8, a controller 810 and a server 820 collaborate to perform radio resource allocation. The server 820 is capable of acquiring the necessary information for resource allocation from the NTN UEs, the TN BSs, and/or the satellite. The controller 810 can use the information collected by the server 810 to decide how to allocate the radio resources. While FIG. 8 only shows one NTN UE 830 and one TN BS 840, there can be a plurality of NTN UEs and a plurality of TN BSs in practice.

At 852 and 854, the controller 810 can send reference signal (RS) configuration information to the TN BS 840 and the satellite 850. The satellite 850 can forward the received RS configuration information at 856 to the NTN UE 830. The TN BS 840 can generate a reference signal based on the RS configuration information, and sends it at 858 to the NTN UE 830. The NTN UE 830 can measure the reference signal based on the RS configuration information and report the measurement results at 860 to the satellite 850. At 862, the satellite 850 can send the measurement results received from the NTN UE 830, together with a measured satellite reference signal at the NTN UE 830 (or a measured NTN UE reference signal at the satellite 850), to the server 820.

At 872, the controller 810 can request the required information from the server 820 by sending a request message. At 874, the server 820 can respond to the controller 810 by sending a response message carrying the required information. In the embodiment shown in FIG. 8, the controller 810 obtains all the necessary information for conducting the radio resource allocation from the server 820. One skilled in the art can conceive that certain portions of the required information can be obtained from alternative sources, for example, the satellite 850.

At 882, the controller 810 can decide how to allocate the radio resources by grouping the NTN UEs, partitioning the radio resources, grouping the TN BSs, and assigning the radio resources between the NTN UEs and TN BSs. At 892 and 894, the controller 810 can transmit the resource allocation results to the TN BS 840 and the satellite 850 for implementation.

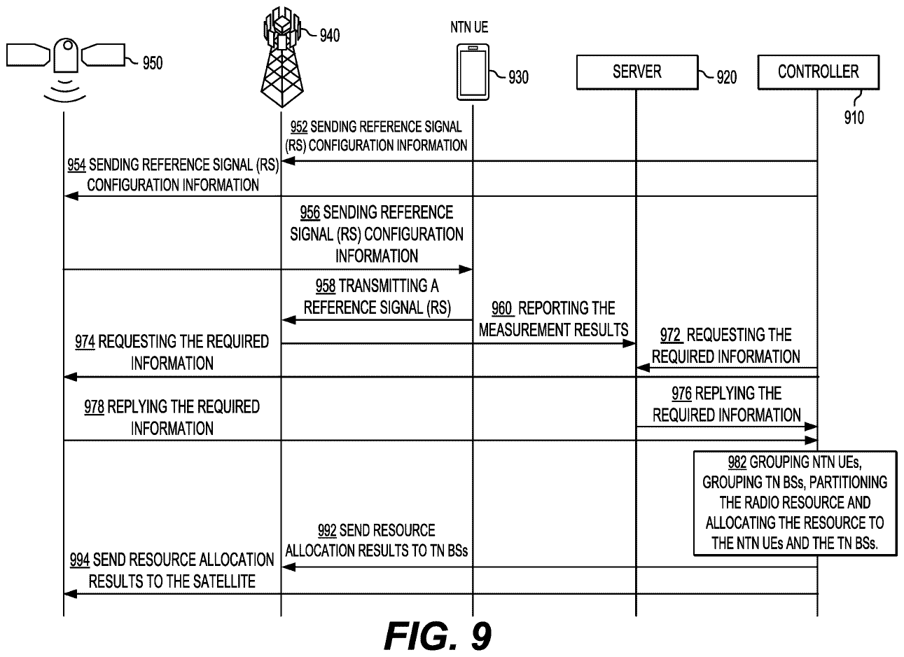

FIG. 9 shows a signal flow chart depicting the interaction between the resource allocation apparatus, the satellite, an exemplary TN BS, and an exemplary NTN UE, in accordance with embodiments of the disclosure. Again, in the scenario shown in FIG. 9, a controller 910 and a server 920 collaborate to perform radio resource allocation. The server 920 is capable of acquiring the necessary information for resource allocation from the NTN UEs, the TN BSs, and/or the satellite. The controller 910 can use the information collected by the server 920 and information provided by the satellite 950 to decide how to allocate the radio resources. While FIG. 9 only shows one NTN UE 930 and one TN BS 940, there can be a plurality of NTN UEs and a plurality of TN BSs in practice.

At 952 and 954, the controller 910 can send reference signal (RS) configuration information to the TN BS 940 and the satellite 950. The satellite 950 can forward the received RS configuration information at 956 to the NTN UE 930. The NTN UE 930 can generate a reference signal based on the RS configuration information, and sends it at 958 to the TN BS 940. The TN BS 940 can measure the reference signal based on the RS configuration information and report the measurement results at 960 to the server 920.

At 972 and 974, the controller 910 can request the required information from the server 920 and the satellite 950 by sending request messages. At 976 and 978, the server 920 and the satellite 950 can respond to the controller 910 by sending response messages carrying the required information. For example, the information sent at 976 can be the NTN UE reference signal measured at the NT BS 940, while the information sent at 978 can be the received RSRP at the satellite 950 from the NTN UE 930.

At 982, the controller 910 can decide how to allocate the radio resources by grouping the NTN UEs, partitioning the radio resources, grouping the TN BSs, and assigning the radio resources between the NTN UEs and TN BSs. At 992 and 994, the controller 910 can transmit the resource allocation results to the TN BS 940 and the satellite 950 for implementation.

While aspects of the present disclosure have been described in conjunction with the specific embodiments thereof that are proposed as examples, alternatives, modifications, and variations to the examples may be made. Accordingly, embodiments as set forth herein are intended to be illustrative and not limiting. There are changes that may be made without departing from the scope of the claims set forth below.

What is claimed is:

1. A user equipment (UE) comprising one or more processors and a transceiver, the UE configured to operate in a mixed system comprising a terrestrial network (TN) and a non-terrestrial network (NTN) that performs in-band spectrum sharing, the UE configured to:
receive, from at least one of a satellite or a TN base station, reference signal (RS) configuration information including one or more RS configuration parameters, the RS configuration information being used for acquiring information used for deciding radio resource allocation for the in-band spectrum sharing between the TN and the NTN is to be transmitted;
based on the RS configuration information, obtain measurement results indicative of coupling loss and/or interference between the TN and the NTN for the in-band spectrum sharing, wherein the measurement results are obtained based on performing at least one of: (i) measure one or more reference signals in accordance with the RS configuration information, and/or (ii) measuring interference on a time-frequency resource in accordance with the RS configuration information;
transmit, in accordance with the RS configuration information, at least one of: (i) a measurement report including the measurement results indicative of coupling loss and/or mutual interference between the TN and the NTN to the satellite, or (ii) an uplink reference signal to the TN base station for measurement by the TN base station, wherein the uplink reference signal is for acquiring information used for deciding the radio resource allocation results for the in-band spectrum sharing;
operate in accordance with resource allocation results implemented by at least one of the satellite or the TN base station, wherein the resource allocation results indicate a partition of shared radio resources to mitigate interference between the TN and the NTN for the in-band spectrum sharing across at least one of a frequency domain, a time domain, and/or a polarization direction; and
communicate using at least one resource portion of the shared radio resources in accordance with the resource allocation results.

2. The UE of claim 1, wherein the one or more RS configuration parameters include at least one of:
an indication of an entity configured to transmit the reference signal, the entity comprising at least one of the UE, the satellite, or the TN base station;
an indication of a resource associated with transmission of the reference signal, the resource comprising at least one of a time-domain resource or a frequency-domain resource; or
an indication of a power-level related parameter associated with the reference signal.

3. The UE of claim 1, wherein the RS configuration information includes uplink RS configuration information indicating at least one RS resource, and wherein the UE is configured to transmit, based on the uplink RS configuration information, the uplink RS to the TN base station for measurement by the TN base station, to derive information indicative of coupling loss used for deciding the radio resource allocation results for the in-band spectrum sharing.

4. The UE of claim 3, wherein the UE operates in a system in which the TN base station is configured to generate measurement results based on the uplink reference signal transmitted by the UE, and to provide at least a portion of the measurement results to a server module for deriving information indicative of coupling loss used for deciding the radio resource allocation results for the in-band spectrum sharing.

5. The UE of claim 3, wherein the UE operates in a system in which the satellite is configured to generate measurement results based on the uplink RS transmitted by the UE, and to provide at least a portion of the measurement results to a server module for deriving information indicative of coupling loss used for deciding the radio resource allocation results for the in-band spectrum sharing.

6. The UE of claim 1, wherein, in accordance with the RS configuration information, the UE is configured to transmit a measurement report including measurement results to the satellite, and wherein the UE operates in a system in which the satellite is configured to forward the measurement report to a server module for deciding the radio resource allocation results for the in-band spectrum sharing.

7. The UE of claim 1, wherein the measurement results comprise at least one channel metric indicative of coupling loss and/or mutual interference between the TN and the NTN, the at least one channel metric including at least one of: RSRP, RSRQ, or channel quality related metric derived based on the one or more reference signals.

8. The UE of claim 1, wherein the in-band spectrum sharing comprises the TN and the NTN sharing a same carrier and sharing at least a portion of time-frequency resources of the shared radio resources.

9. The UE of claim 1, wherein the radio resources assigned to the UE comprise one or more time-frequency resource units, including at least one of resource blocks or other resource units.

10. The UE of claim 1, wherein, responsive to implementation of resource allocation results by at least one of a satellite or a TN base station, the UE is configured to operate under a configured cell by performing at least one of: accessing a cell, leaving a cell, or communicating via a cell in accordance with cell configuration information corresponding to the radio resource allocation results.

11. The UE of claim 10, wherein the UE is configured to transmit an acknowledgement indicating reception of the cell configuration information or cell deconfiguration.

12. The UE of claim 1, wherein the UE operates in a system in which a control function for determining resource allocation results including the partition of the shared radio resources is implemented by a plurality of function modules, the plurality of function modules comprising at least a controller module and a server module, and wherein the plurality of function modules are implemented as a single unit or divided into separate modules.

13. The UE of claim 12, wherein the UE operates in a system in which at least one portion of the control function is performed by the satellite and at least one portion of the control function is performed by the TN base station.

14. The UE of claim 12, wherein the UE operates in a system in which the plurality of entities exchange at least one of the acquired information, the RS configuration information, or the measurement results to determine a partition of the shared radio resources.

15. The UE of claim 12, wherein the UE operates in a system in which the control function groups a plurality of NTN UEs into a plurality of NTN UE groups and groups a plurality of TN base stations into a plurality of TN base station groups, and determines the partition based on the plurality of NTN UE groups and the plurality of TN base station groups.

16. The UE of claim 15, wherein the UE operates in a system in which the partition comprises multiple resource portions each associated with an NTN UE group among the plurality of NTN UE groups and a TN base station group among the plurality of TN base station groups.

17. A method performed by a user equipment (UE) in a mixed TN and NTN system that performs in-band spectrum sharing, the method comprising:
receiving, from at least one of a satellite or a TN base station, reference signal (RS) configuration information, the RS configuration information including information regarding how a reference signal used for acquiring information used for deciding radio resource allocation between the TN and the NTN is to be transmitted;
obtaining, based on the RS configuration information, measurement results indicative of coupling loss and/or interference between the TN and the NTN for the in-band spectrum sharing, by performing at least one of: (i) measure one or more reference signals in accordance with the RS configuration information, and/or (ii) measuring interference on a shared time-frequency resource in accordance with the RS configuration information;
transmitting, in accordance with the RS configuration information, at least one of: (i) a measurement report including the measurement results indicative of coupling loss and/or mutual interference between the TN and the NTN to the satellite, or (ii) an uplink reference signal to the TN base station for measurement by the TN base station, wherein the uplink reference signal is for acquiring information used for deciding the radio resource allocation results for the in-band spectrum sharing;
operating in accordance with resource allocation results implemented by at least one of the satellite or the TN base station, wherein the resource allocation results indicate a partition of shared radio resources to mitigate interference between the TN and the NTN for the in-band spectrum sharing across at least one of a frequency domain, a time domain, and/or a polarization direction; and
communicating using at least one resource portion of the shared radio resources in accordance with the resource allocation results.

18. The method of claim 17, further comprising:
receiving cell configuration information or cell deconfiguration information; and
transmitting an acknowledgement indicating reception of the cell configuration information or the cell deconfiguration; and
accessing a cell or leaving a cell in accordance with an updated cell configuration.

19. A non-transitory computer-readable medium storing instructions that, when executed by one or more processors of a user equipment (UE), cause the UE to perform a method in a mixed terrestrial network (TN) and non-terrestrial network (NTN) system, the method comprising:
receive, from at least one of a satellite or a TN base station, reference signal (RS) configuration information, the RS configuration information including information regarding how a reference signal used for acquiring information used for deciding radio resource allocation between the TN and the NTN is to be transmitted;
based on the RS configuration information, obtain measurement results indicative of coupling loss and/or interference between the TN and the NTN for the in-band spectrum sharing, by performing at least one of: (i) measure one or more reference signals in accordance with the RS configuration information, and/or (ii) measuring interference on a shared time-frequency resource in accordance with the RS configuration information;
transmit, in accordance with the RS configuration information, at least one of: (i) a measurement report including the measurement results indicative of coupling loss and/or mutual interference between the TN and the NTN to the satellite, or (ii) an uplink reference signal to the TN base station for measurement by the TN base station, wherein the uplink reference signal is for acquiring information used for deciding the radio resource allocation results for the in-band spectrum sharing;
operate in accordance with resource allocation results implemented by at least one of the satellite or the TN base station, wherein the resource allocation results indicate a partition of shared radio resources to mitigate interference between the TN and the NTN for the in-band spectrum sharing across at least one of a frequency domain, a time domain, and/or a polarization direction; and
communicate using at least one resource portion of the shared radio resources in accordance with the resource allocation results.

20. The non-transitory computer-readable medium of claim 19, wherein the instructions further cause the UE to perform:
receiving cell configuration information or cell deconfiguration information; and
transmitting an acknowledgement indicating reception of the cell configuration information or the cell deconfiguration; and
accessing a cell or leaving a cell in accordance with an updated cell configuration.
